(19) United States
(12) Patent Application Publication
(10) Pub. No.: US 2014/0169265 A1
(43) Pub. Date: Jun. 19, 2014

(54) COMMUNICATION METHOD OF BASE STATION AND TERMINAL IN COMMUNICATION SYSTEM INCLUDING RELAY

(71) Applicant: Electronics and Telecommunications Research Institute, Daejeon (KR)

(72) Inventors: Hyun Seo PARK, Daejeon (KR); Jaesheung SHIN, Daejeon (KR); Sung-Min OH, Daejeon (KR); Ae-Soon PARK, Daejeon (KR)

(73) Assignee: Electronics and Telecommunications Research Institute, Daejeon (KR)

(21) Appl. No.: 14/089,323

(22) Filed: Nov. 25, 2013

(30) Foreign Application Priority Data
Dec. 14, 2012 (KR) 10-2012-0146701

(51) Int. Cl. H04W 40/22; H04W 40/36

(52) U.S. Cl. CPC H04W 40/22; H04W 40/36
USPC 370/315

(57) ABSTRACT

A communication method of a terminal and a base station including a relay is provided. When the terminal attempts a connection to the base station, relays on a communication path include and transmit identifiers thereof in a first message, and the relays and the base station can simply set a communication path to the terminal. When the base station transmits data to the terminal, if the base station includes and transmits an identifier of the terminal in the data, each relay that is located on a communication path forwards data through a preset communication path.

### CROSS-REFERENCE TO RELATED APPLICATION

This application claims priority to and the benefit of Korean Patent Application No. 10-2012-0146701 filed in the Korean Intellectual Property Office on Dec. 14, 2012, the entire contents of which are incorporated herein by reference.

### BACKGROUND OF THE INVENTION

(a) Field of the Invention

The present invention relates to a communication method of a base station and a terminal in a communication system including a relay. More particularly, the present invention relates to a method in which a terminal and a base station communicate through at least one relay.

(b) Description of the Related Art

A method of increasing a system capacity by constructing many various small cells such as a long term evolution (LTE) pico cell, a femto cell, or a Wi-Fi access point (AP) has been in the spotlight as a solving method that prepares for a rapid increase of mobile data. Because it requires a large cost to install a light infrastructure in every small cell, wireless backhaul has garnered interest, and relay technology that wirelessly connects a small cell to a macro base station using a macro base station as a mother base station has also been in the spotlight.

When constructing a small cell using a super-high frequency (SHF)/extremely high frequency (EHF) band for rapid increase of mobile data, communication is available only in a line-of-sight (LOS) environment, thus for wireless connection to a macro base station, a small cell using an SHF/EHF band requests multihop relay technology that passes through a plurality of relays. In a multihop relay environment, as there are many relays to pass through in order to transmit and receive data between a macro base station and a terminal exist, there is a problem that overhead increases. Particularly, S1-U protocol overhead such as GTP/UDP/IP and Un protocol overhead such as PDCP/RLC are added to a layer 3 relay in which standardization is performing in LTE-Advanced, and thus when a base station and a terminal transmit and receive data, efficiency may be considerably deteriorated. Further, when formed with multihops, the overhead may be increased to larger than actual data.

### SUMMARY OF THE INVENTION

The present invention has been made in an effort to provide a communication method of a base station and a terminal in a communication system including a relay that can reduce overhead to a minimum when communicating with the terminal and the base station through at least one relay.

An exemplary embodiment of the present invention provides a method in which a base station communicates with a terminal through a relay. The method includes: setting a communication path to the terminal through the relay using an identifier of the terminal and an identifier of the relay; and performing data communication with the terminal through the relay using the identifier of the terminal and the identifier of the relay.

A cell-radio network temporary identifier (C-RNTI) may be used as the identifier of the terminal and the identifier of the relay, and the C-RNTI may be included in a medium access control (MAC) control element.

The setting of a communication path may include receiving a connection request message from the terminal through at least one relay when the terminal attempts a connection to the base station, wherein the connection request message may include the identifier of the terminal and the identifier of the relay having transmitted the connection request message by the at least one relay.

The receiving of a connection request message may include: forwarding, by a relay of a first hop to which the terminal connects, a connection request message including an identifier of the terminal to a next hop; and forwarding, by a relay of the next hop, the connection request message including an identifier of a relay of a previous hop to the next hop.

The setting of a communication path may further include storing, by a relay having received the connection request message, a communication path to the base station using the identifier of the terminal and the identifier of the relay that are included in the connection request message.

The performing of data communication may include transmitting, by a relay of the first hop of the terminal having received an uplink traffic message from the terminal, the uplink message including the identifier of the terminal; and forwarding, by a relay in a communication path to the base station when receiving the uplink traffic message, the uplink traffic message to the next hop according to the communication path.

The setting of a communication path may further include transmitting a connection setting message corresponding to a response of the connection request message to the terminal through the at least one relay, wherein the connection setting message may include the identifier of the terminal and identifiers of the remaining relays, except for first hop among relays that are located on the communication path by the base station and may be forwarded to the next hop.

An identifier of a first relay that is included in the connection setting message may be deleted by a relay of each hop having received the connection setting message, and the connection setting message may be forwarded to the identifier of the first relay.

The setting of a communication path may further include storing, by a relay having received the connection setting message, a communication path to the terminal using the identifier of the terminal and the identifier of the relay that are included in the connection setting message.

The performing of data communication may include transmitting a downlink traffic message including the identifier of the terminal to a relay of the next hop on the communication path to the terminal; and transmitting, by a relay on the communication path to the terminal, the received downlink traffic message to the next hop according to the communication path.

The method may further include supporting handover of the terminal through the relay using the identifier of the terminal and the identifier of the relay.

The supporting of handover may include receiving a handover complete message that newly attempts a connection from the terminal through at least one relay, wherein the handover complete message may include an identifier of a terminal or a relay having transmitting a message by the at least one relay and may be forwarded to the next hop.

The receiving of a handover complete message may include transmitting, by a relay of the first hop to which the terminal connects, the handover complete message including an identifier of the terminal; and forwarding, by a relay of the next hop, the handover complete message including an identifier of a relay of the previous hop having forwarded the handover complete message to the next hop.

The supporting of handover may further include storing, by a relay having received the handover complete message, a communication path to the base station using the identifier of the terminal and the identifier of the relay that are included in the handover complete message.

Another embodiment of the present invention provides a communication method of a relay between a base station and a terminal. The communication method includes: receiving, by a relay of a first hop to which the terminal connects, a connection request message from the terminal, when the terminal attempts a connection to the base station; forwarding, by the relay of the first hop, a connection request message including an identifier of the terminal to a next hop;

forwarding, by a relay of the next hop, the connection request message including an identifier of a relay of the previous hop to the next hop; and storing, by the relay of the first hop and the relay of the next hop, a communication path to the base station using the identifier of the terminal and the identifier of the relay that are included in the connection request message.

The communication method may further include: transmitting, by the relay of the first hop of the terminal having received an uplink traffic message from the terminal, the uplink message including the identifier of the terminal; and forwarding, by a relay in a communication path to the base station when receiving the uplink message, the uplink message to the next hop according to the communication path.

The communication method may further include: receiving, by a relay of the first hop that is connected to the base station, a connection setting message including the identifier of the terminal and identifiers of the remaining relays, except for the relay of the first hop among relays that are located on a communication path in response to the connection request message from the base station; and deleting, by the relay of the first hop, an identifier of a relay of the next hop from the connection setting message and transmitting the connection setting message to the relay of the next hop.

The communication method may further include storing, by the first relay and the relay of the next hop having received the connection setting message, a communication path to the terminal using the identifier of the terminal and the identifier of the relay that are included in the connect setting message.

The communication method may further include: receiving, by the relay of the first hop to which the terminal connects, a handover complete message that newly attempts a connection from the terminal; transmitting, by the relay of the first hop to which the terminal connects, the handover complete message including the identifier of the terminal; and forwarding, by a relay of the next hop, the handover complete message including an identifier of a relay of the previous hop, having forwarded the handover complete message to the next hop.

The communication method may further include storing, by a first relay and a relay of the next hop having received the handover complete message, a communication path to the base station using the identifier of the terminal and the identifier of the relay that are included in the handover complete message.

### BRIEF DESCRIPTION OF THE DRAWINGS

FIG. 1 is a diagram illustrating an example of a wireless communication system according to an exemplary embodiment of the present invention.

FIG. 2 is a diagram illustrating a method of setting a data path according to an exemplary embodiment of the present invention.

FIG. 3 is a diagram illustrating a downlink communication method of a macrocell base station and a terminal according to an exemplary embodiment of the present invention.

FIG. 4 is a diagram illustrating an uplink communication method of a macrocell base station and a terminal according to an exemplary embodiment of the present invention.

FIG. 5 is a diagram illustrating a data path change method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a communication method of a base station and a terminal in a communication system including a relay according to an exemplary embodiment of the present invention will be described in detail with reference to the drawings.

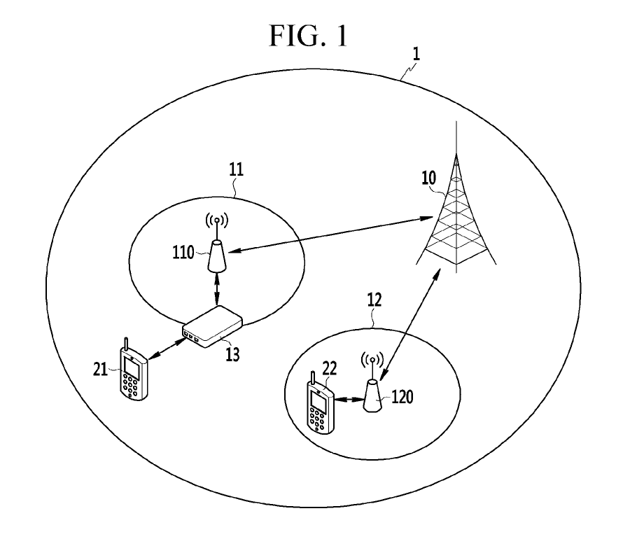

FIG. 1 is a diagram illustrating an example of a wireless communication system according to an exemplary embodiment of the present invention.

Referring to FIG. 1, the wireless communication system includes at least one of small cells 11 and 12 within a macrocell 1.

The macrocell 1 has a wide cell radius, for example, a radius of about 1 km, and the small cells 11 and 12 have a smaller radius than that of the macrocell 1. For example, the small cell may include a long term evolution (LTE) pico cell, a femto cell, or a Wi-Fi access point (AP).

The macrocell 1 includes a macrocell base station 10 that manages the macrocell 1. Further, the small cells 11 and 12 include small cell base stations 110 and 120 that manage the small cells 11 and 12.

The macrocell base station 10 allocates a cell-radio network temporary identifier (C-RNTI), which is a temporary identifier in the macrocell 1, to each of terminals 21 and 22, small cell base stations 110 and 120, and a relay 13, thereby recognizing the terminals 21 and 22, the small cell base stations 110 and 120, and the relay 13 in the macrocell 1.

The small cell base stations 110 and 120 are generally installed at a weak radio area within a building or a user congestion area, and are connected to the macrocell base station 10. In this case, the small cell base station 120 may perform a relay function for communication with the terminal 22 and the macrocell base station 10.

The relay 13 using a wireless interface as backhaul for the small cell base station 110 may exist, and the terminal 21 may communicate with the small cell base station 110 through the relay 13.

In this way, in a wireless communication system that passes through at least one relay for wireless connection of the terminals 21 and 22 and the macrocell base station 10, for efficient communication between the terminals 21 and 22 and the macrocell base station 10, a method of setting a simple data path between the terminals 21 and 22 and the macrocell base station 10 is necessary while reducing overhead to the minimum.

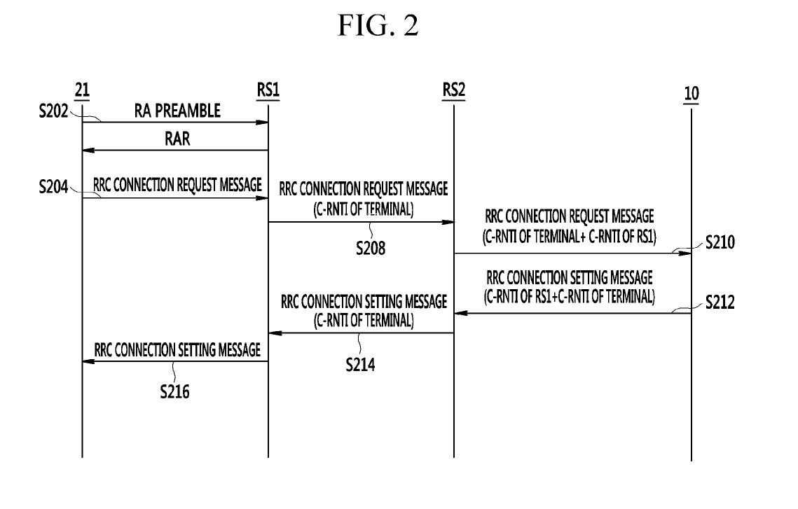

FIG. 2 is a diagram illustrating a method of setting a data path according to an exemplary embodiment of the present invention. For convenience of description, in FIG. 2, it is assumed that two relays RS1 and RS2 exist between the terminal 21 and the macrocell base station 10, and the two relays RS1 and RS2 are layer 2 relays.

Referring to FIG. 2, the terminal 21 transmits a random access RA1 preamble to the relay RS1 corresponding to a first hop to attempt RA (S202).

The relay RS1, having received the RA preamble, transmits a random access response (RAR) in a response thereto. The RAR may include a C-RNTI that the terminal 21 is to use and an uplink resource. It is assumed that only the C-RNTI may be identified within the macrocell base station 10. In this case, a C-RNTI range that may be allocated may be previously determined for each of the relays RS1 and RS2.

The terminal 21 transmits a radio resource control (RRC) connection request message to the relay RS1 to request RRC connect setting (S204). The macrocell base station 10 finally receives and processes the RRC connection request message.

The relay RS1, having received the RRC connection request message, adds a C-RNTI of the terminal 21 having transmitted the RRC connection request message to a source C-RNTI to forward the RRC connection request message to the relay RS2 corresponding to a next hop (S208). Here, the source C-RNTI represents a C-RNTI having transmitted a message, and may be included in a medium access control (MAC) control element.

The relay RS1 stores data path information that the terminal 21 has been connected to the relay RS1.

A MAC control element that is defined for data path setting between the terminal 21 and the macrocell base station 10 is shown in Table 1. Such a MAC control element may be included in a MAC header.

TABLE 1

| Direction | Index | LCID | Length |
|---|---|---|---|
| UL (base station -> | 11010 | source C-RNTI | 16 bits |
| terminal) | | | |
| DL (terminal -> | 11000 | target C-RNTI | 16 bits |
| base station) | | | |

That is, when an index of a MAC control element of a corresponding message is 11010, a value of a logical channel identifier (LCID) field represents a source C-RNTI, and when an index of a MAC control element of a corresponding message is 11000, a value of an LCID field represents a target C-RNTI. Here, the index value may be changed.

The relay RS2, having received the RRC connection request message, adds a C-RNTI of the relay RS1 having transmitted the RRC connection request message to a source C-RNTI to the RRC connection request message, and forwards the RRC connection request message to a next hop-in macrocell base station 10 (S210). The relay RS2 stores data path information that the terminal 21 has been connected to the relay RS2 via the relay RS1.

The macrocell base station 10, having received the RRC connection request message, stores data path information that the terminal 21 has been connected to the macrocell base station 10 via the relay RS2 and the relay RS1 through a source C-RNTI of the received RRC connection request message.

The macrocell base station 10 transmits an RRC connection setting message in a successful response to the RRC connection request message of the terminal 21 (S212). In this case, the macrocell base station 10 includes a C-RNTI of the relay RS1 that is located on a data path to the terminal 21 and a C-RNTI of the terminal 21 as a target C-RNTI in the RRC connection setting message, and transmits an RRC connection setting message to a first hop-in relay RS2 as a receiver that is located on a data path to the terminal 21. Here, the target C-RNTI represents a receiver to transmit a message.

However, when the RRC connection setting message is a failure response to the RRC connection request message of the terminal 21, the macrocell base station 10 transmits an RRC connection failure message to the relay RS2 and enables each of the relays RS1 and RS2 on a data path to the terminal 21 to release a resource of the corresponding terminal 21.

The relay RS2 having received the RRC connection setting message deletes a C-RNTI of the relay RS1 from a target C-RNTI of the RRC connection setting message, and forwards the RRC connection setting message to the relay RS1 as a receiver (S214).

The relay RS1 having received the RRC connection setting message deletes a C-RNTI of the terminal 21 from the target C-RNTI of the RRC connection setting message, and forwards the RRC connection setting message to the terminal 21 as a receiver (S216).

The terminal 21, having received the RRC connection setting message, performs the remaining procedure for RRC connect setting to complete RRC connect setting. When RRC connect setting is complete, data communication between the macrocell base station 10 and the terminal 21 may be performed.

In this way, according to an exemplary embodiment of the present invention, by setting a data path between the terminal 21 and the macrocell base station 10 through an RRC connection setting procedure, even if many relays exist between the terminal 21 and the macrocell base station 10, overhead may not additionally occur.

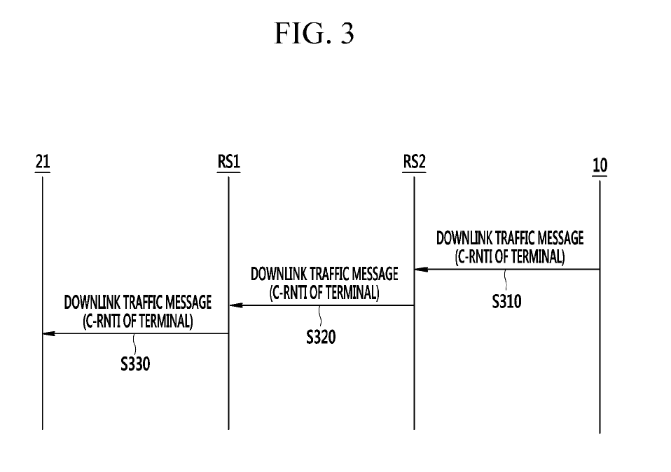

FIG. 3 is a diagram illustrating a downlink communication method of a macrocell base station and a terminal according to an exemplary embodiment of the present invention.

Referring to FIG. 3, the macrocell base station 10 includes a C-RNTI of the terminal 21 as a target C-RNTI in a downlink traffic message to transmit, and transmits the downlink traffic message to a first hop-in relay RS2 as a receiver on a data path to the terminal 21 (S310).

The relay RS2 having received the downlink traffic message determines the target C-RNTI, and transmits the downlink traffic message to a next hop-in relay RS1 on a data path to the terminal 21 (S320).

Next, the relay RS1, having received the downlink traffic message determines the target C-RNTI, deletes the target C-RNTI from the downlink traffic message when the target C-RNTI corresponds to a next hop on a data path to the terminal 21, and transmits the downlink traffic message to the terminal 21, which is a final receiver (S330).

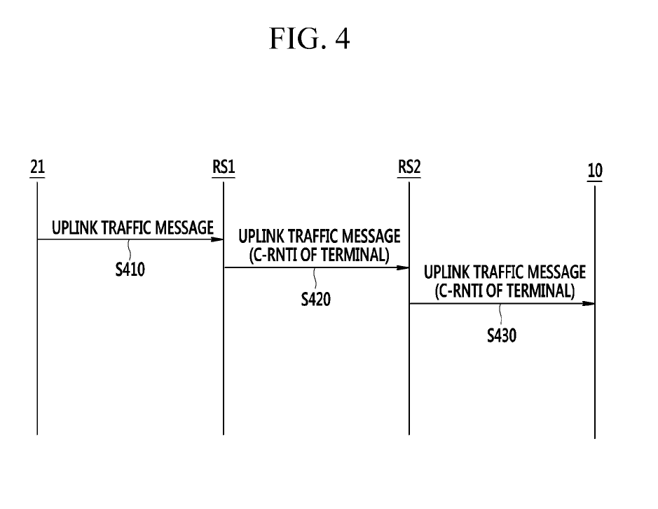

FIG. 4 is a diagram illustrating an uplink communication method of a macrocell base station and a terminal according to an exemplary embodiment of the present invention.

Referring to FIG. 4, the terminal 21 transmits an uplink traffic message to the first hop-in relay RS1 on a data path to the macrocell base station (S410).

The relay RS1 having received the uplink traffic message includes a C-RNTI of the terminal 21 as a source C-RNTI in the uplink traffic message, and transmits the uplink traffic message to a next hop-in relay RS2 (S420).

The relay RS2 having received the uplink traffic message transmits the uplink traffic message to the macrocell base station 10, which is a final base station (S430).

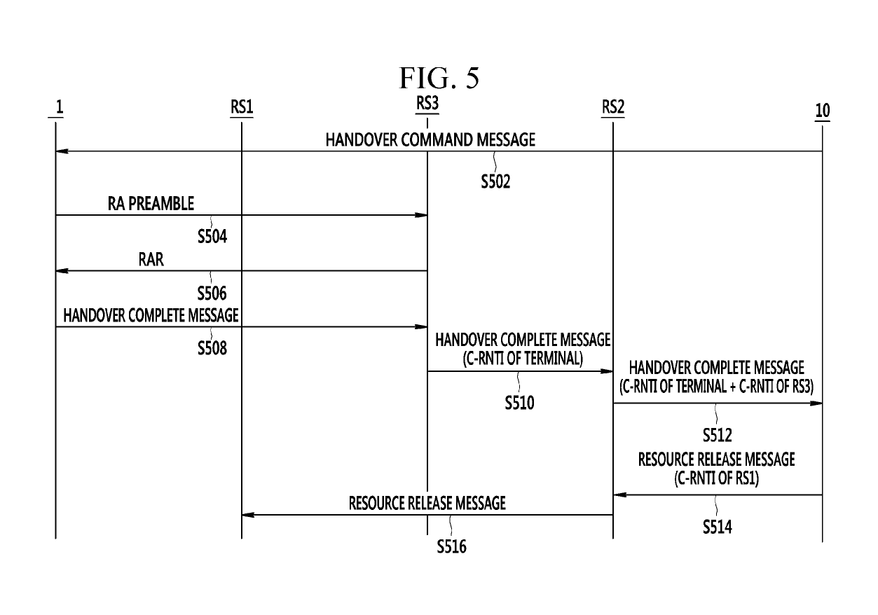

FIG. 5 is a diagram illustrating a data path change method according to an exemplary embodiment of the present invention.

Referring to FIG. 5, the macrocell base station 10 transmits a handover command message that instructs to perform handover from a relay RS1 to a relay RS3, to the terminal 21 (S502).

The terminal 21 having received the handover command message interrupts a connection to the relay RS1, and transmits an RA preamble to the relay RS3 to attempt RA (S504).

The relay RS3 having received the RA preamble transmits an RAR in response thereto to the terminal 21 (S506). The RAR may include an uplink resource and a C-RNTI that the terminal 21 is to use.

The terminal 21 transmits a handover complete message to notify the macrocell base station 10 that handover has succeeded.

That is, the terminal 21 transmits a handover complete message to the relay RS3 (S508). The relay RS3, having received the handover complete message, adds a C-RNTI of the terminal 21, having transmitted the handover complete message as a source C-RNTI to the handover complete message, and forwards the handover complete message to a next hop-in relay RS2 (S510). The relay RS3 stores data path information that the terminal 21 has been connected to the relay RS3.

The relay RS2, having received the handover complete message, adds a C-RNTI of the relay RS3, having transmitted the handover complete message as a source C-RNTI to the handover complete message, and forwards the handover complete message to a next hop-in macrocell base station 10 (S512). The relay RS2 stores data path information that the terminal 21 has been connected to the relay RS2 via the relay RS3.

The macrocell base station 10 having received the handover complete message stores data path information that the terminal 21 has been connected to the macrocell base station 10 via the relay RS2 and the relay RS3.

Next, in order to release a resource of the terminal 21 that is allocated to the relay RS1, the macrocell base station 10 includes a C-RNTI of the relay RS1 as a target C-RNTI in a resource release message and transmits the resource release message to the relay RS2 as a receiver (S514).

The relay RS2 having received the resource release message deletes a C-RNTI of the relay RS1 from the resource release message, and forwards the resource release message to the relay RS1 to the C-RNTI of the relay RS1 as a receiver (S516).

The relay RS2 having received the resource release message releases a resource that is allocated to the terminal 21.

That is, when handover occurs by movement of the terminal 21, each of the relays RS2 and RS3 and the macrocell base station 10 set a data path between the terminal 21 and the macrocell base station 10 through a handover procedure. Therefore, while the terminal communicates, overhead may not be additionally generated by data path setting.

According to an exemplary embodiment of the present invention, in a multihop relay environment, even when many relays to pass through in order to transmit and receive data between a macro base station and a terminal exist, while reducing overhead, communication can be performed.

Further, in a multihop relay environment, a data path between a macro base station and a terminal can be easily set, and when the terminal moves within the macro base station, in order to prevent data from being lost, data can be retransmitted within the base station without an additional method and thus in a handover situation, performance deterioration can be remarkably reduced.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a base station communicates with a terminal through a relay, the method comprising:
setting a communication path to the terminal through the relay using an identifier of the terminal and an identifier of the relay; and
performing data communication with the terminal through the relay using the identifier of the terminal and the identifier of the relay.

2. The method of claim 1, wherein a cell-radio network temporary identifier (C-RNTI) is used as the identifier of the terminal and the identifier of the relay, and the C-RNTI is included in a medium access control (MAC) control element.

3. The method of claim 1, wherein the setting of a communication path comprises receiving a connection request message from the terminal through at least one relay, when the terminal attempts a connection to the base station,
wherein the connection request message comprises the identifier of the terminal and the identifier of the relay, having transmitted the connection request message by the at least one relay.

4. The method of claim 3, wherein the receiving of a connection request message comprises:
forwarding, by a relay of a first hop to which the terminal connects, a connection request message comprising an identifier of the terminal to a next hop; and
forwarding, by a relay of the next hop, the connection request message comprising an identifier of a relay of a previous hop to the next hop.

5. The method of claim 3, wherein the setting of a communication path further comprises
storing, by a relay having received the connection request message, a communication path to the base station using the identifier of the terminal and the identifier of the relay that are included in the connection request message.

6. The method of claim 5, wherein the performing of data communication comprises:
transmitting, by a relay of first hop of the terminal having received an uplink traffic message from the terminal, the uplink message comprising the identifier of the terminal; and
forwarding, by a relay in a communication path to the base station when receiving the uplink traffic message, the uplink traffic message to the next hop according to the communication path.

7. The method of claim 3, wherein the setting of a communication path further comprises transmitting a connection setting message corresponding to a response of the connection request message to the terminal through the at least one relay,
wherein the connection setting message comprises the identifier of the terminal and identifiers of the remaining relays, except for the first hop among relays that are located on the communication path by the base station, and is forwarded to the next hop.

8. The method of claim 7, wherein an identifier of a first relay that is included in the connection setting message is deleted by a relay of each hop having received the connection setting message, and the connection setting message is forwarded to the identifier of the first relay.

9. The method of claim 7, wherein the setting of a communication path further comprises storing, by a relay having received the connection setting message, a communication path to the terminal using the identifier of the terminal and the identifier of the relay that are included in the connection setting message.

10. The method of claim 9, wherein the performing of data communication comprises:
transmitting a downlink traffic message comprising the identifier of the terminal to a relay of the next hop on the communication path to the terminal; and
transmitting, by a relay on the communication path to the terminal, the received downlink traffic message to the next hop according to the communication path.

11. The method of claim 1, further comprising supporting handover of the terminal through the relay using the identifier of the terminal and the identifier of the relay.

12. The method of claim 11, wherein the supporting of handover comprises receiving a handover complete message that newly attempts a connection from the terminal through at least one relay,
wherein the handover complete message comprises an identifier of a terminal or a relay having transmitting a message by the at least one relay and is forwarded to the next hop.

13. The method of claim 12, wherein the receiving of a handover complete message comprises:
transmitting, by a relay of the first hop to which the terminal connects, the handover complete message comprising an identifier of the terminal; and
forwarding, by a relay of the next hop, the handover complete message comprising an identifier of a relay of the previous hop having forwarded the handover complete message to the next hop.

14. The method of claim 13, wherein the supporting of handover further comprises storing, by a relay having received the handover complete message, a communication path to the base station using the identifier of the terminal and the identifier of the relay that are included in the handover complete message.

15. A communication method of a relay between a base station and a terminal, the communication method comprising:
receiving, by a relay of a first hop to which the terminal connects, a connection request message from the terminal, when the terminal attempts a connection to the base station;
forwarding, by the relay of the first hop, a connection request message comprising an identifier of the terminal to a next hop;
forwarding, by a relay of the next hop, the connection request message comprising an identifier of a relay of the previous hop to the next hop; and
storing, by the relay of the first hop and the relay of the next hop, a communication path to the base station using the identifier of the terminal and the identifier of the relay that are included in the connection request message.

16. The communication method of claim 15, further comprising:
transmitting, by the relay of the first hop of the terminal having received an uplink traffic message from the terminal, the uplink message comprising the identifier of the terminal; and
forwarding, by a relay in a communication path to the base station when receiving the uplink message, the uplink message to the next hop according to the communication path.

17. The communication method of claim 15, further comprising:
receiving, by a relay of the first hop that is connected to the base station, a connection setting message comprising the identifier of the terminal and identifiers of the remaining relays, except for the relay of the first hop among relays that are located on a communication path in response to the connection request message from the base station; and
deleting, by the relay of the first hop, an identifier of a relay of the next hop from the connection setting message and transmitting the connection setting message to the relay of the next hop.

18. The communication method of claim 17, further comprising storing, by the first relay and the relay of the next hop having received the connection setting message, a communication path to the terminal using the identifier of the terminal and the identifier of the relay that are included in the connect setting message.

19. The communication method of claim 15, further comprising:
receiving, by the relay of the first hop to which the terminal connects, a handover complete message that newly attempts a connection from the terminal;
transmitting, by the relay of the first hop to which the terminal connects, the handover complete message comprising the identifier of the terminal; and
forwarding, by a relay of the next hop, the handover complete message comprising an identifier of a relay of the previous hop, having forwarded the handover complete message to the next hop.

20. The communication method of claim 19, further comprising storing, by a first relay and a relay of the next hop having received the handover complete message, a communication path to the base station using the identifier of the terminal and the identifier of the relay that are included in the handover complete message.
